(19) United States
(12) Patent Application Publication
(10) Pub. No.: US 2008/0024739 A1
(43) Pub. Date: Jan. 31, 2008

(54) PROJECTOR

(75) Inventor: Takeshi KITAKATA, Kuwana (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 11/863,982

(22) Filed: Sep. 28, 2007

Related U.S. Application Data
(63) Continuation-in-part of application No. PCT/JP2006/306117, filed on Mar. 27, 2006.

(30) Foreign Application Priority Data
Mar. 30, 2005 (JP) 2005-097954

(51) Int. Cl. G03B 21/14

(52) U.S. Cl. 353/101

(57) ABSTRACT

A projector is provided with an image source configured to form an image to be projected, a projection lens, and a relay lens configured to transfer the optical image formed by the image source to an entrance pupil of the projection lens. At least a part of the relay lens is configured to be movable along a direction of an optical axis thereof.

### CROSS-REFERENCE TO RELATED APPLICATIONS

This is a Continuation-in-Part of International Application No. PCT/JP2006/30177 filed Mar. 27, 2006, which claims priority from Japanese Patent Application No. 2005-097954 filed on Mar. 30, 2005. The entire disclosure of the prior applications is hereby incorporated by reference herein its entirety.

### BACKGROUND

1. Technical Field

The present invention relates to a projector which projects an image onto a screen.

2. Related Art

Various types of projectors which project images onto a screen are known, such as an LC (Liquid Crystal) projector, a DLP (Digital Light Processing) projector, and an LCOS (Liquid Crystal on Silicon) projector (which is a high reflective liquid crystal projector).

Generally, a projector has two optical systems: an illuminating optical system which emits an optical image to be projected; and an imaging optical system which forms the optical image on a screen. Between the two optical systems, a field lens is placed, by which the optical image is transferred from the illuminating optical system to the imaging optical system.

In the projector using a reflective display device, an optical path of the illuminating optical system is arranged between optical paths of the imaging optical system. With this configuration, it is possible to design a downsized projector. In order to adopt such a reflective optical system, the imaging optical system is required to have a relatively large back focus.

However, in designing the image optical system, it is difficult to achieve a wide angle of view and a large back focus while retaining its open f-number. In order to design such an optical system, a number of lenses increases and/or a diameter of the lens becomes larger, which may lead to increase of a manufacturing cost and/or lowering a performance.

In addition, the optical image which is formed by the image display device in the illuminating optical system is transferred to an entrance pupil of the imaging optical system. At the time, a loss of luminous flux is smaller as values of a direction cosine viewed from the imaging optical system to the image display device become smaller. In particular, if the image display device has formed with birefringent material, such as a liquid crystal, a retardation varies depending on an angle of incidence. Therefore, a quality of a magnified image is degraded when the values of the direction cosine are large. Therefore, it is desirable that the imaging optical system has telecentricity on the image display device side.

However, it makes the design more difficult to provide the imaging optical system with telecentricity and a large back focus.

Conventionally, such a problem is solved by dividing an imaging optical system into a projection lens and a relay lens. Examples of such a projector is described in Japanese Patent Provisional Publication No. 2000-155288 and Japanese Patent Provisional Publication No. 2002-162688.

In the projectors described in the above publications, however, focusing of the imaging optical system and/or changing of magnification if the projected image cannot be done easily in such conventional projectors.

### SUMMARY OF THE INVENTION

The present invention is advantageous in that there is provided an improved projector in which focusing and varying of the magnification can be performed relatively easily.

According to aspects of the invention, there is provided a projector is provided with an image source configured to form an image to be projected, a projection lens, and a relay lens configured to transfer the optical image formed by the image source to an entrance pupil of the projection lens. At least a part of the relay lens is configured to be movable along a direction of an optical axis thereof.

Therefore, by moving the entire relay lens or a part of it in the direction of the optical axis thereof, focusing and/or zooming can be performed easily without moving projection lens.

It should be noted that, hereinafter, throughout the specification, the word “lens” is used to mean both a single lens element and a lens including a group of lens elements.

### BRIEF DESCRIPTION OF THE ACCOMPANYING DRAWINGS

FIG. 1 is a block diagram which shows a schematic configuration of a projector according to an embodiment of the present invention.

FIG. 2 is an illustration which shows a schematic configuration of a projector according to an embodiment of the present invention.

FIG. 3A is a diagram which shows an example of a configuration of a relay lens.

FIG. 3B is a diagram which shows the relay lens shown in FIG. 3A when the movable lens elements have been moved symmetrically.

FIG. 4A is a diagram which shows the relay lens shown in FIG. 3A when the movable lens elements have been moved asymmetrically in a positive direction.

FIG. 4B is a diagram which shows the relay lens shown in FIG. 3A when the movable lens elements have been moved asymmetrically in a negative direction.

### DETAILED DESCRIPTION OF THE EMBODIMENT

Hereinafter, referring to the accompanying drawings, a projector according to an embodiment of the invention will be described.

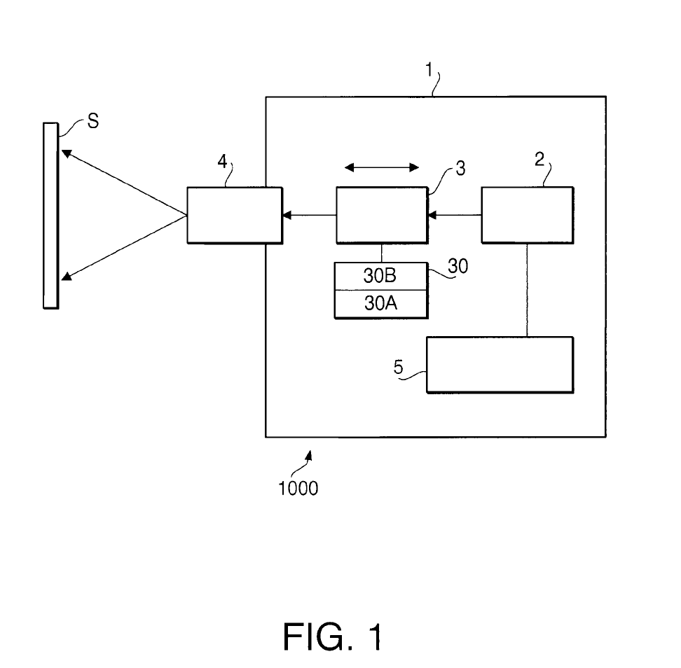

FIG. 1 is a diagram showing a schematic configuration of the projector 1000. The projector 1000 is provided with a housing 1, an illuminating optical system 2, a relay lens 3, a projection lens 4 and a control unit 5 as main configuration elements.

The housing 1 is configured such that the projection lens 4 can be detachably attached. The housing 1 accommodates the illuminating optical system 2, the relay lens 3 and the control unit 5.

The projection lens 4 can be detachably attached to the housing 1 with a structure (e.g., one employed in a single-lens reflex camera: bayonet structure). The projection lens 4 has predetermined characteristics such as a necessary angle of view and an f-number. It is desirable that a plurality of projection lenses 4 having different characteristics are ready to be used (i.e., exchanged) to meet various requirements.

The illuminating optical system 2 is configured to emit an optical image to the relay lens 3. The illuminating optical system 2 includes an image display device to form an optical image to be projected. As an image display device, various devices can be used such as a DMD (Digital Mirror Device) used in a DPL projector in addition to a liquid crystal device. As an optical system (lens system) of the illuminating optical system 2, various existing illuminating optical systems can be used.

The relay lens 3 is positioned where the lens can transfer the optical image from the illuminating optical system 2 to the projection lens 4. Between the relay lens 3 and the illuminating optical system 2, a field lens is placed for effective transfer to the pupil. It is desirable that the relay lens 3 is of a symmetric type of which a lens power on an object side and a lens power on an image side are symmetric with respect to an aperture stop (Gauss type, Triplet type, Tessar type, etc.). It is because a distortion and a chromatic aberration of magnification can be compensated when such a symmetric type relay lens 3 is employed. The distortion and the chromatic aberration are of a problem particularly when a wide-angle lens is used as the projection lens 4. It should be noted that the relay lens can also be of an asymmetric type, i.e., a lens of which a lens power on the object side and a lens power on the image side are asymmetric with respect to the aperture stop can be used.

According to the illustrative embodiment, the relay lens 3 is substantially telecentric on both the projection lens 4 side and the illuminating optical system 2 side. It should be noted that, although the illustrative embodiment employs the telecentricity, the non-telecentric system can also be employed.

In addition, in the embodiment, the relay lens 3 is movable in a direction of the optical axis of thereof. The relay lens 3 may have a group of lenses. In such a case, the entire relay lens 3 or a part of the group of lenses may be configured to be movable back and forth along the optical axis.

There is provided a mechanism 30 to drive the relay lens 3 in the direction of the optical axis. Various kinds of driving mechanisms may be used. For example, as the driving mechanism, a rack and pinion, or a mechanism employing a ball screw may be used. Optionally, the mechanism 30 may include a normal driving mechanism 30A for driving the relay lens 3 (for a relatively rough movement) by a relatively large amount and a fine driving mechanism 30B for fine adjustment (i.e., a minute movement) of the location of the relay lens 3.

The control unit 5 has a function to control an operation of the image display device of the illuminating optical system 2 to produce a desired optical image, and a function to supply electric power necessary to activate the illuminating optical system 2. Further, in the embodiment, the control unit 5 has a function to control operations of the moving mechanism 30 (e.g., timing of a movement, amount of a movement).

Then, operations of the projector 1000 according to the embodiment of the present invention are described. Firstly, based on instructions and a power supply from the control unit 5, the desired optical image is formed by the illuminating optical system 2. The generated optical image is transferred to the relay lens 3. The optical image transferred to the relay lens 3 is further transferred to the projection lens 4. The optical image transferred to the projection lens 4 is enlarged by the lens 4 to the necessary magnification, and projected onto the screen S.

As described above, the entire relay lens 3 or a part of the relay lens 3 may be moved along the direction of the optical axis. By moving the relay lens 3, it is possible to project an in-focus image on the screen S and change magnification.

It should be noted that, even if the relay lens 3 is completely telecentric on both sides, a dimension of the image which is transferred to the entrance pupil or to the exit pupil may vary as a part of the relay lens 3 is moved. Therefore, it is possible to change magnification of the projected image.

Further, if the relay lens 3 is not completely telecentric or telecentricity is lost because of movement of a part of the relay lens 3 (group of lenses thereof), dimension of the transferred image may be changed by moving the relay lens 3.

In addition, since the location of the focus position of the image transferred from the pupil of the relay lens 3 to the pupil of the projection lens 4 varies by moving the whole relay lens or a part of the relay lens, it is possible to focus the projection lens 4.

As aforementioned, it is relatively difficult to design a mechanism to move the projection lens 4, since the projection lens 4 protrudes from the housing 1. On the other hand, it is relatively easy to design a mechanism to move the relay lens since the relay lens is inside the housing 1. In addition, since the relay lens 3 is generally easy to be designed compactly compared to the projection lens 4, the moving mechanism of the lens 3 can also be made compact, and there is an advantage where the whole projector can be designed in compact size and lightweight.

According to the embodiment, since the relay lens 3 is substantially telecentric on both sides thereof (i.e., on the illuminating optical system 2 side and on the projection lens 4 side), when the relay lens 3 is moved along the direction of the optical axis, a dimension of the optical image transferred to the projection lens 4 remains almost the same. Therefore, when the relay lens 3 is moved in the direction of the optical axis, a dimension of the image projected onto the screen varies very little.

In addition, since the projection lens 4 can be exchanged according to the embodiment, a desired one of the projection lenses 4 with various magnification or characteristics may be used depending on purposes. In other words, since each projection lens 4 can be designed for a single purpose, the design of the projection lens 4 (the imaging optical system) may be simplified.

As a result, a lightweight and compact design of the projection lens 4 may be easily achieved. Accordingly, there is an advantage that weight or volume of the entire projector 1000 can also be smaller and the projector 1000 is easy to be carried with the projection lens 4 being attached thereto.

Further, as the design of the projection lens 4 is simplified, the projection lens 4 can be supplied at lower cost.

Since the relay lens 3 is employed in the projector according to the embodiment, it is not necessary that the projection lens 4 is configured have a relatively large back focus. Therefore, design of the projection lens 4 may be further simplified, and thus, the projection lens 4 can be further lighter weighed and the manufacturing cost may be further lowered.

Further, even if the location of the entrance pupils of the projection lenses 4 attachable to the projector 1000 are different, an optical image of the almost same dimension can be transferred to respective projection lenses 4 since the relay lens 3 is substantially telecentric on the side of the projection lens 4. Therefore, in the design of the projection lens 4, the design can be easier because of the increased degree of freedom of the location of the entrance pupil thereof.

Further, if the relay lens 3 is substantially telecentric on the side of the illuminating optical system 2, a quality of the optical image which is magnified with the projection lens 4 can be improved.

As mentioned above, in a usual imaging optical system, in order to obtain telecentricity on the side of the illuminating optical system 2, a consistency with other characteristics (e.g., angle of view, or f-number) is required. It is relatively difficult to design the imaging optical system to meet such a requirement. In contrast, according to the embodiment since the relay lens 3 is used and telecentricity is achieved by the relay lens 3, there is an advantage that telecentricity on the side of the illuminating optical system 2 can be easily achieved. In addition, characteristics such as angle of view required in the imaging optical system can be achieved relatively easily in a combination of the projection lens 4 and the relay lens 3.

Further, since the relay lens 3 is telecentric on both of the object side and the image side, the direction cosine of the light ray is extremely small or zero. Accordingly, there is an advantage that a value of the third order aberration of the projection lens 4 is not degraded so much.

Furthermore, according to the embodiment, since the relay lens 3 is used, the relay lens 3 can be designed to compensate for the third order aberration of the projection lens 4. Then, the projection lens 4 may be designed further easily, and there is an advantage that an imaging optical system with high image quality can be easily designed.

As mentioned above, the projector 1000 may include the normal moving mechanism 30A which moves the whole relay lens 3 or a part of the relay lens along the direction of the optical axis and the fine adjusting mechanism 30B which adjusts a location of the whole relay lens 3 or a part of the relay lens. Thus, a fine adjustment can be executed after the lens is roughly moved, and the fine adjustment can be done and the lens is positioned accurately in a short time.

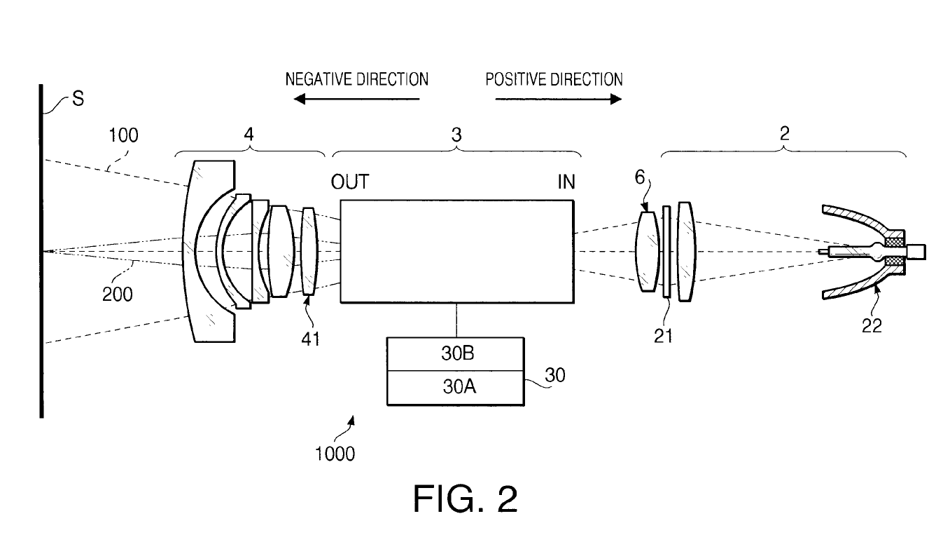

An exemplary structure of the projector 1000 is shown in FIG. 2. Portions corresponding to elements shown in FIG. 1 are given the same reference numerals.

In the example shown in FIG. 2, the illuminating optical system 2 forms an optical image using an image display device 21 configured with a transmissive liquid crystal. In addition, the illuminating optical system 2 is provided with a light source 22.

In this example, a field lens 6 is arranged between the relay lens 3 and the illuminating optical system 2 to transfer the optical image from the illuminating optical system 2 to the relay lens 3. The projection lens 4 includes a defocal lens 41 for adjusting a position of the image plane.

In the FIG. 2, the reference character 100 indicates a light trajectory of the illumination system, and the reference character 200 indicates a light trajectory of the imaging system.

An optical performance of the relay lens 3 (including a case where the relay lens includes a group of lenses) is described below in further details, when the relay lens 3 is moved.

The relay lens 3 has a defocusing function when moved in the positive direction or in the negative direction along the optical axis (see FIG. 2). Therefore, even if a position of the screen S is not changed, a dimension of the light trajectory of the imaging system is changed as the relay lens 3 moves, and it is possible to adjust the focal position. When amount of travel of the relay lens 3 is larger, it is possible to adjust magnification of the image (i.e., adjustment of a dimension of the image projected onto the screen S). Thus, the relay lens can function as a zoom lens.

In addition, it is also possible to apply defocusing and zooming by moving a part of (i.e., some lens elements of) the relay lens 3, which will be described in detail.

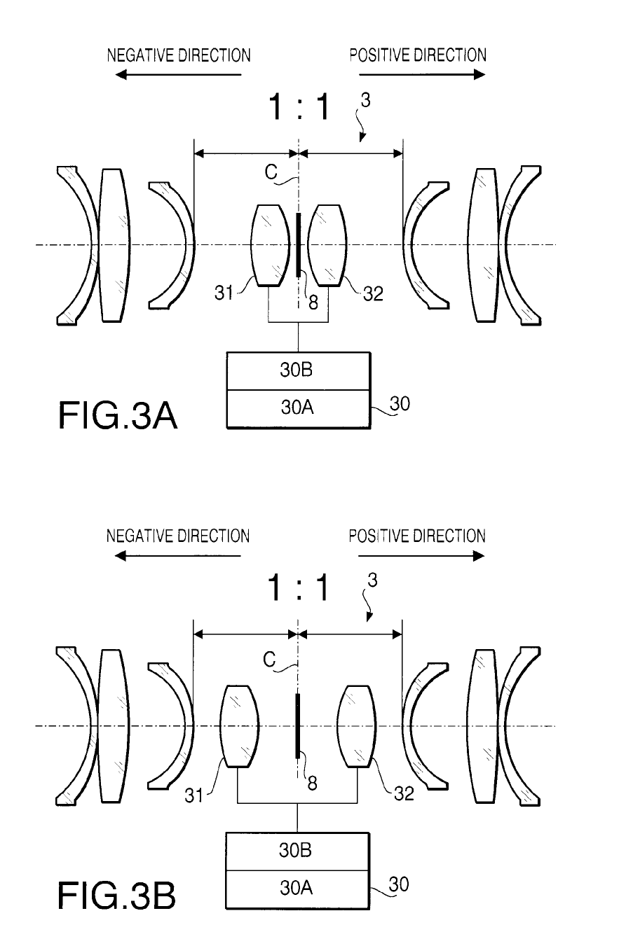

FIG. 3A shows an example of a symmetric lens system, which is symmetric in terms of power on both sides with respect to an aperture stop 8. As such a symmetric lens, Gauss type lens, Triplet type lens, Tessar type lens, etc., are known. In this example, there are two movable lenses 31 and 32, which are symmetric in terms of power, on each side of the aperture stop 8. These movable lenses 31 and 32 are moved by the moving mechanism 30 back and forth along the direction of the optical axis (i.e., movable in the positive direction and in the negative position). It should be noted that, in FIG. 3A, the aperture stop is located at the central position (i.e., an axis of symmetry of the power of the relay lens) C of the relay lens 3.

FIG. 3B shows a state where the movable lenses 31 and 32 have been moved by the same amount in the positive and negative direction, respectively, with respect to the central position C of the relay lens. In this case, the interval between the movable lens 31 and the movable lens 32 becomes larger in comparison with a sate shown in FIG. 3A. With this movement, a convergent point of is extended, and defocus is applied.

If the relay lens 3 is telecentric on both sides or on the image side (i.e., on the screen side), there is an advantage where a height of the image remains the same even if the position of the image is shifted in the direction of the optical axis.

It is possible that a lens on the light incident since of the relay lens 3 may be configured to have a relatively small diameter so that the light rays have a certain incident angle. In this case, an angle of the light rays emerged from the lens on the light emerging side of the relay lens 3 can be made substantially zero (i.e., telecentric). With such a configuration, a diameter of the lens can be made small, and the manufacturing cost can be reduced.

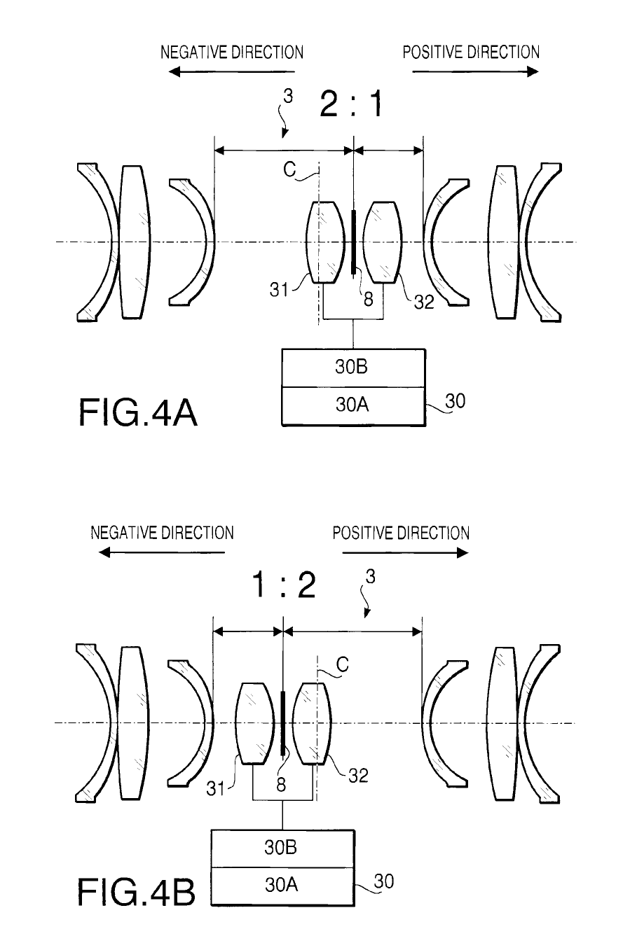

FIG. 4A shows a status where the movable lenses 31 and 32 are moved as a whole to the positive direction (to the right-hand side in FIG. 4). In this case, the movable lenses 31 and 32 constituting parts of the relay lens 3 are moved asymmetrically with respect to the central position C, in the direction of the optical axis, of the relay lens 3 (or asymmetrically with respect to the entire relay lens 3). It should be noted that the other portions of the relay lens 3 are the same as the case shown in FIG. 3A. In this case, due to the positional relationship of the movable lenses 31 and 32 with respect to the other lenses as indicated in FIG. 4A, the light directed to the negative direction is emitted at a height two times higher than that of the light on the positive direction side.

FIG. 4B shows a case where the movable lenses 31 and 32 are moved as a whole to the negative direction (to the left-hand side in FIG. 4). In this case, the movable lenses 31 and 32 constituting parts of the relay lens 3 are also moved asymmetrically with respect to the central position C, in the direction of the optical axis, of the relay lens (or, asymmetrically with respect to the entire relay lens 3). Also in this case, the other portions of the relay lens 3 are the same as the arrangement shown in FIG. 3A. In this case, due to the positional relationship of the movable lenses 31 and 32 with respect to the other lenses as indicated in FIG. 4B, the light on the positive direction side has a height two times higher than that of the light on the negative direction side.

As described above, by moving parts of the relay lens 3 (e.g., lenses 31 and 32) asymmetrically, with respect to the entire relay lens 3, as shown in FIG. 4A and FIG. 4B, it is possible to differentiate the height of light rays at the entrance side of the relay lens 3 and that at the exit side of the relay lens 3. Therefore, a magnification of the image can be varied (i.e., zooming is performed) by moving the parts of the relay lens 3 (e.g., lenses 31 and 32).

It should be noted that the invention is not limited to the above-described illustrative embodiment or the examples. Rather, various modifications of the above-described embodiment/examples can be made within the scope of the invention.

What is claimed is:

1. A projector comprising:
an image source configured to form an image to be projected;
a projection lens; and
a relay lens configured to transfer the optical image formed by the image source to an entrance pupil of the projection lens, at least a part of the relay lens being configured to be movable along a direction of an optical axis thereof.

2. The projector according to claim 1,
wherein the relay lens comprises two lens elements arranged symmetrically in terms of power thereof with respect to a central position, in the direction of the optical axis of the relay lens, the two lens elements being movable symmetrically with respect to the central position of the relay lens.

3. The projector according to claim 1,
wherein the relay lens comprises two lens elements arranged symmetrically in terms of power thereof with respect to a central position, in the direction of the optical axis, of the relay lens, the two lens elements being movable asymmetrically with respect to the central position of the relay lens.

4. The projector according to claim 1, further comprising:
a moving mechanism configured to roughly move the at least a part of the relay lens along the optical axis; and
a fine adjusting mechanism configured to minutely move the at least a part of the relay lens along the optical axis.

5. The projector according to claim 1, further comprising a zooming mechanism which adjusts a size of a projected optical image, the zooming mechanism moving at least a part of the relay lens along the optical axis.

6. The projector according to claim 5, wherein the zooming mechanism is configured to move the entire relay lens along the optical axis.

7. The projector according to claim 5,
wherein the relay lens comprises two lens elements arranged symmetrically in terms of power thereof with respect to a central position, in the direction of the optical axis, of the relay lens, the two lens elements being movable asymmetrically with respect to the central position of the relay lens.

8. The projector according to claim 1, further comprising a focusing mechanism, the focusing mechanism moving at least a part of the relay lens along the optical axis.

9. The projector according to claim 8, wherein the zooming mechanism is configured to move the entire relay lens along the optical axis.

10. The projector according to claim 8,
wherein the relay lens comprises two lens elements arranged symmetrically in terms of power thereof with respect to a central position, in the direction of the optical axis, of the relay lens, and
wherein the focusing mechanism adjusts a focus position of an object image by moving the two lens elements symmetrically with respect to the central position of the relay lens along the optical axis.

11. The projector according to claim 1,
wherein the relay lens is configured to be telecentric on both of the image source side and the projection lens side.
